(19) United States
(12) Patent Application Publication
(10) Pub. No.: US 2012/0002036 A1
(43) Pub. Date: Jan. 5, 2012

(54) Method and Device for Scanning Induction Thermography Having a Flexible Movement Path

(75) Inventors: Matthias Goldammer, Muenchen (DE); Max Rothenfusser, Munchen (DE); Johannes L. Vrana, Berlin (DE)

(73) Assignee: SIEMENS AKTIENGESELLSCHAFT, Muenchen (DE)

(21) Appl. No.: 13/003,887

(22) PCT Filed: May 22, 2009
(86) PCT No.: PCT/EP2009/056233

§ 371 Date: Jan. 13, 2011

(30) Foreign Application Priority Data
Jul. 22, 2008 (DE) 10 2008 034 162.2

(51) Int. Cl. H04N 7/18

(52) U.S. Cl. 348/86; 348/92; 348/E07.085; 901/7

(57) ABSTRACT

A method and a device for induction thermography for non-destructive material examination are provided. A movement of a test object relative to an infrared camera with an inductor is carried out along any desired single or multi-dimensional path such that the relative movement for recording an image by the infrared camera is independent.

### CROSS REFERENCE TO RELATED APPLICATIONS

This application is the US National Stage of International Application No. PCT/EP2009/056233 filed May 22, 2009, and claims the benefit thereof. The International Application claims the benefits of German Patent Application No. 10 2008 034 162.2 DE filed Jul. 22, 2008. All of the applications are incorporated by reference herein in their entirety.

### FIELD OF INVENTION

The present invention relates to a method and a device for induction thermography for non-destructive material examination.

### BACKGROUND OF INVENTION

Induction thermography is a method for non-destructive material examination. An alternating current, flowing in a coil, referred to as the inductor, induces a current in the electrically conductive test object. This is represented in FIG. 1a. If a component exhibits a crack, the current which flows through the test object must flow round such a crack. This is represented in FIG. 1b. Owing to the increased current density, the test object is heated more strongly at the crack. This can be proved with an infrared camera. This is represented in FIG. 1c. Only a narrow area near the inductor is heated. This is represented in FIG. 1d. Therefore, for a complete test of large components or components of complex shape many individual examinations have to be conducted.

To test components of large surface area for cracks other methods are conventionally used, such as for example the dye penetration test. For applications of induction thermography several individual examinations are conventionally carried out to cover a large area. Few options are available conventionally for a large area examination of components by means of induction thermography.

In [1] the following is proposed: For defects which are located inside a material the test object is shifted during measurement in synchronization with the frequency of the camera. The test object is shifted by one pixel per camera image. Such a process is represented in FIG. 2. The induction generator works in continuous wave operation. To reconstruct an image the data are resorted. The evaluation is then conducted by subtracting the zero image or by the fit of a sixth-degree polynomial and subsequent evaluation of the first or second derivative.

In [2] a method is disclosed in which a test object is positioned in front of a set of inductors and the individual points are excited in succession. In this way complex objects can be examined, but because several inductors have to be used the method requires considerable time and effort.

### SUMMARY OF INVENTION

An object of the present invention is to provide a simple method and a device for induction thermography with which large components and/or components of complex shape can be quickly and reliably examined for material defects. The aim in particular is to be able to examine a large surface of a component in a simple manner.

The object is achieved by a method and a device in accordance with the independent claims. In the prior art a full image is produced every time the test object is moved a length corresponding to the projected pixel width. By contrast, in accordance with the present invention the movement of the test object relative to an infrared camera having an inductor is provided such that the relative movement for recording the image with the infrared camera is uncoupled and/or free. In this way, large areas of the component can be examined simply and at high speed. The movement of the test object takes place along any single or multi-dimensional path. Any point of the test object can be heated. Either, the infrared camera and the inductor remain stationary, or the camera is moved together with the inductor, with the specimen remaining stationary.

Advantageously, large test objects and test objects of complex shape can be quickly examined for defects. The time and effort required for the test are significantly reduced and an easy-to-interpret image of the result is obtained. In this way it is also easy to document the results. Furthermore, it is possible by means of the evaluation to evaluate the result automatically.

Further advantageous embodiments are claimed in connection with the dependent claims.

In accordance with one advantageous embodiment the relative movement is carried out by means of sliding tables for an x, a y and/or a z direction.

In accordance with a further advantageous embodiment the relative movement is carried out by means of a conveyor, for example a belt conveyor or a roller conveyor.

In accordance with a further advantageous embodiment the relative movement takes place by means of a device for rotating a rotationally symmetric test object.

In accordance with a further advantageous embodiment the relative movement is carried out by means of a robot.

In accordance with a further advantageous embodiment an induction generator is operated in continuous wave mode.

In accordance with a further advantageous embodiment the heating of a point of the test object as the inductor approaches and/or its cooling after the inductor has passed is recorded by an infrared camera, which in each case captures two or more images.

In accordance with a further advantageous embodiment the camera data are resorted in adaptation to a path and a speed in such a way that one point of a results series for the temperature over a period of time corresponds to one point of the test object. Through a resorting of the data in adaptation to the path and the speed, whereby the camera is not synchronized with the travel speed, one point of the results series corresponds to one point of the specimen.

In accordance with a further advantageous embodiment a single image is produced from the results series by evaluating the data, taking into account the heating and cooling process. By suitable evaluation of the data in the heating and cooling process one result can be represented as one image.

In accordance with a further advantageous embodiment zero image correction or pulse phase analysis evaluation algorithms are used. Possible evaluation algorithms include algorithms for zero image correction and pulse phase analysis, in particular when using the phase image which suppresses the emissivity differences and differences in the current density distribution.

In accordance with a further advantageous embodiment image areas without information are masked out. By masking out image areas without information the image quality can be improved. Such image areas arise, for example, because they are covered by the inductor.

In accordance with a further advantageous embodiment geometric effects caused by the shape of the test object are suppressed by subtracting an image sequence of an intact test object from an image of a defective test object or by subtracting these two result images after evaluation by pulse phase analysis. This means that geometric effects, for example caused by grooves or edges, can be suppressed by subtracting a sequence of a good part or by subtracting the two result images after evaluation by, for example, pulse phase analysis. This improves the detection of defects.

In accordance with a further advantageous embodiment a result image is saved for defect documentation. In particular, a result image produced by subtracting a sequence of a good part or by subtracting result images can be saved for defect documentation.

In accordance with a further advantageous embodiment the test object is positioned at a point, a camera image is recorded, these data are evaluated, and the test object is positioned at another point, in such a way that in particular by superimposing the camera images a result image is created for the entire test object. This is a point by point procedure. It therefore provides a further possibility of moving the specimen, capturing an image at this point, evaluating these data with the methods previously mentioned and finally moving the specimen to the next point. In this way it is also possible to obtain a result image for the entire test object by superimposing the result images.

In accordance with a further advantageous embodiment an online evaluation is carried out as the image is being captured. In addition to offline evaluation, it is therefore possible to perform an online evaluation as the image is being captured.

In accordance with a further advantageous embodiment an automatic evaluation is carried out. It is therefore possible to evaluate a result automatically either online or offline.

### BRIEF DESCRIPTION OF THE DRAWINGS

The present invention is described with reference to exemplary embodiments in connection with the following figures:

FIGS. 1a, 1b, 1c, 1d represent the mode of operation of induction thermography.

FIG. 2 is an exemplary embodiment of a conventional device for induction thermography.

FIG. 3a is a first exemplary embodiment of a device for induction thermography in accordance with the invention.

FIG. 3b is a second exemplary embodiment of a device for induction thermography in accordance with the invention.

FIG. 3c is a third exemplary embodiment of a device for induction thermography in accordance with the invention.

FIG. 3d is a fourth exemplary embodiment of a device for induction thermography in accordance with the invention.

### DETAILED DESCRIPTION OF INVENTION

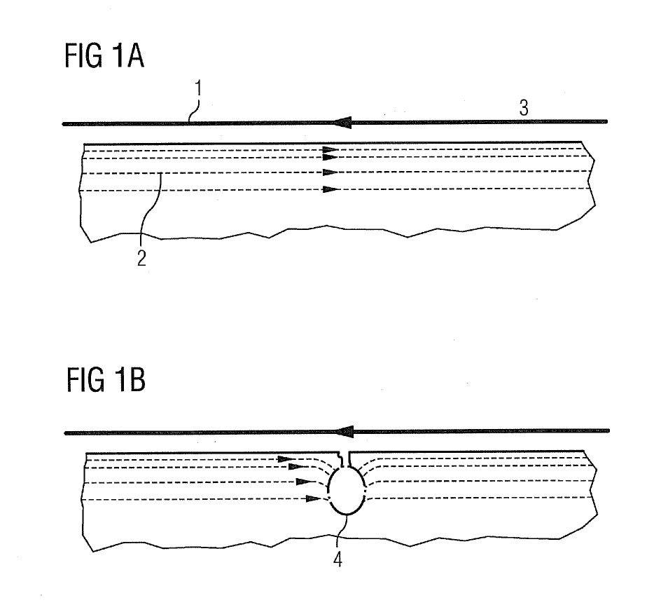

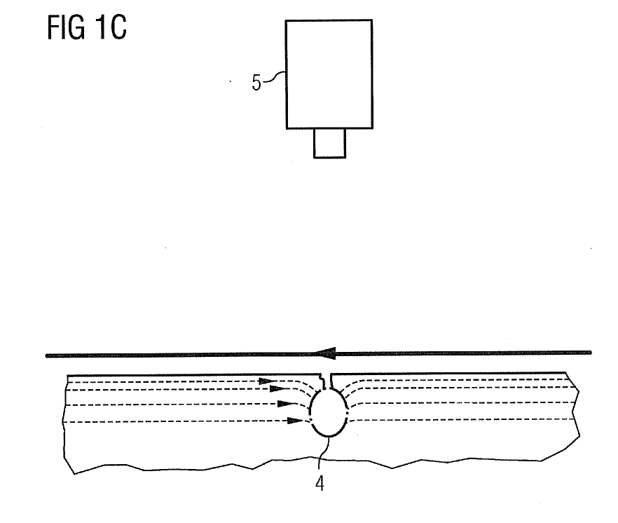

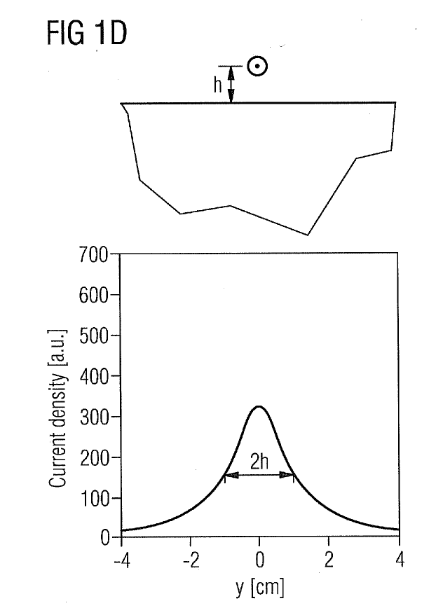

FIGS. 1a, 1b, 1c and 1d represent the mode of operation of induction thermography. FIG. 1a shows with reference number 1 an inductor or a coil through which an alternating current flows. Reference number 2 indicates the induced currents. Reference number 3 indicates the alternating current. The alternating current 3, which flows in the coil or in the inductor 1, induces a current in the electrically conductive test object.

FIG. 1b shows with reference number 4 an area with increased current density as a result of a crack in the test object. This causes an increased generation of heat at the top of the crack. This means that if a component contains a crack, the current flowing through the test object must flow around the crack.

FIG. 1c indicates with reference number 4 the area of increased current density which causes an increased generation of heat at the top of the crack. The reference number 5 indicates an infrared camera. Through the increased current density the test object is heated more strongly at the crack, as can be proved with the infrared camera 5.

FIG. 1d shows that merely a narrow area near the inductor is heated. FIG. 1d shows a drawing of the current density as a function of the distance y.

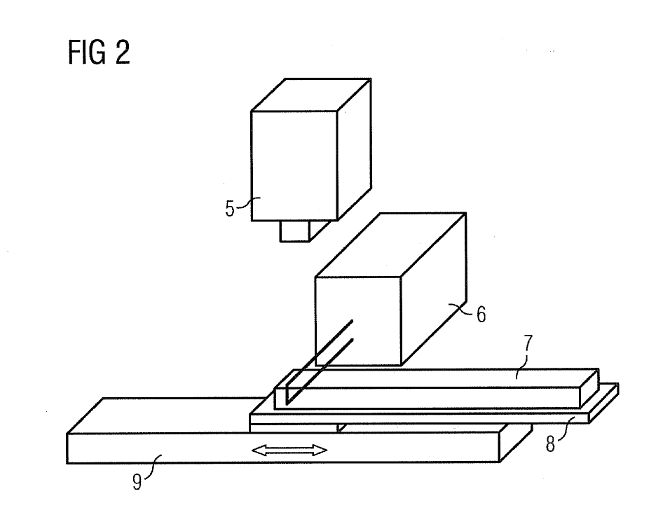

FIG. 2a shows an exemplary embodiment of a conventional device for induction thermography in accordance with [1]. Reference number 5 indicates an infrared camera, reference number 6 an induction generator with inductor, reference number 7 indicates a test object, reference number 8 indicates a holder for the test object. Reference number 9 indicates a sliding table. For defects located inside the material it is recommended according to the prior art to shift the test object during measurement, in synchronization with the frequency of the camera, with the test object being shifted one pixel per camera image.

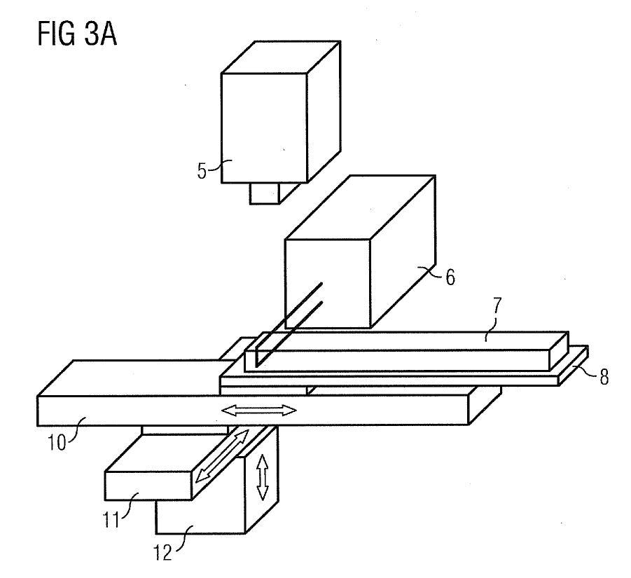

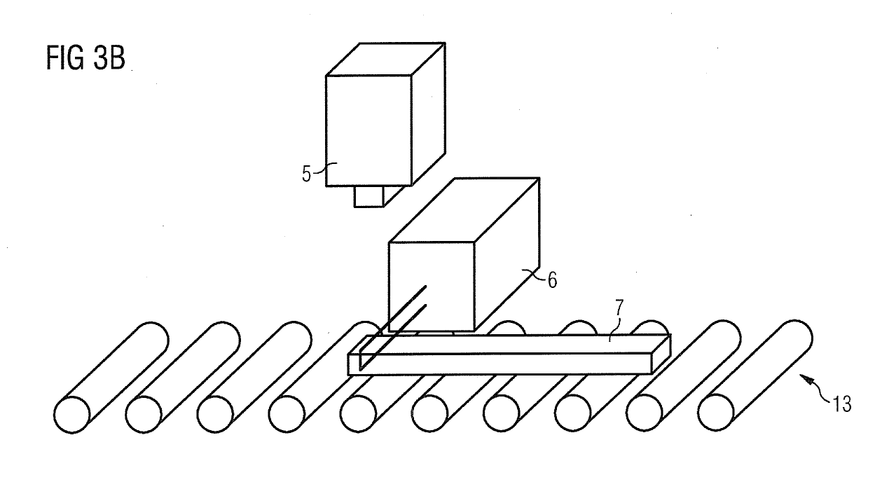

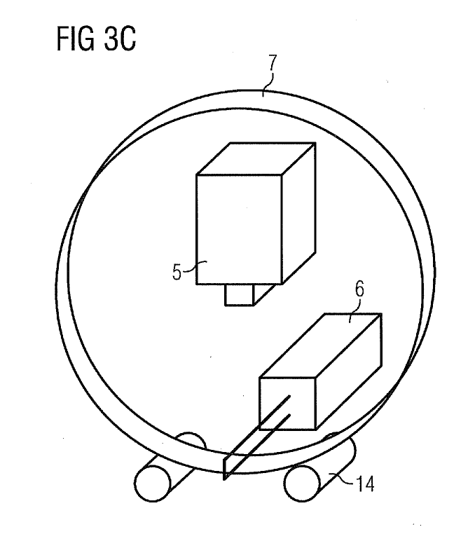

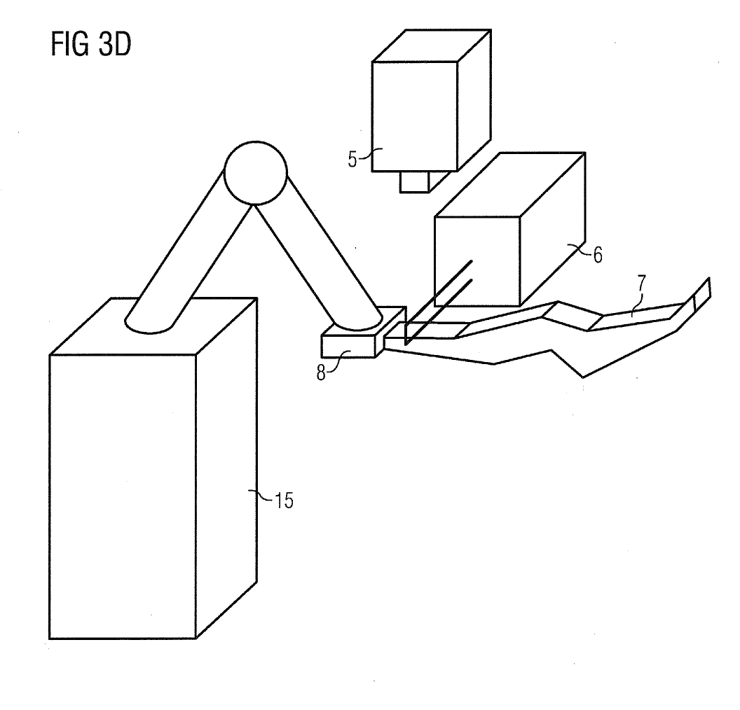

FIG. 3a shows a first exemplary embodiment of a device for induction thermography in accordance with the invention. Reference number 5 indicates an infrared camera, reference number 6 an induction generator with inductor, reference number 7 a test object. Reference number 8 indicates a holder for the test object. Reference number 10 indicates a sliding table for an x direction. Reference number 11 indicates a sliding table for a y direction. Reference number 12 indicates a sliding table for a z direction.

FIG. 3b shows a second exemplary embodiment of a device for induction thermography in accordance with the invention. Reference number 5 indicates an infrared camera, reference number 6 an induction generator with inductor and reference number 7 a test object. Reference number 13 indicates a belt conveyor or a roller conveyor.

FIG. 3c represents a third exemplary embodiment of a device for induction thermography in accordance with the invention. Reference number 5 indicates an infrared camera. Reference number 6 an induction generator with inductor. Reference number 14 indicates a device for rotating the test object. The test object is indicated with reference number 7.

FIG. 3d shows a fourth exemplary embodiment of a device for induction thermography in accordance with the invention. In this case a test object 7 is positioned by means of a robot 15. Reference number 5 indicates an infrared camera. Reference number 6 indicates an induction generator with inductor. Reference number 8 indicates a holder for the test object.

### REFERENCES

[1] Steven M. Shepard et al., “Development of NDE Technique with Induction Heating and Thermography on Conductive Composite Materials”, Thermal Wave Imaging, Inc. Farndale, Mich., University of Delaware, Center for Composite Materials (UD-CCM), Newark, Del., July 2004
[2] Dr. Udo Netzelmann et al., “Zerstörungsfreie thermographische Methoden der Detektion von Fehlern an Massivumform-Teilen”, Saarbrücken, Schmiede-Journal, pages 26-28, March 2007

1.-17. (canceled)

18. A method of scanning induction thermography for a non-destructive material examination of a test object, comprising:
providing a test object;
providing an inductor including an infrared camera; and
moving the test object relative to the inductor including the infrared camera along any single or multi-dimensional path, wherein a relative movement of the test object is independent from recording an image by the infrared camera.

19. The method as claimed in claim 18, wherein the relative movement is carried out by sliding tables for an x, a y and/or a z direction.

20. The method as claimed in claim 18, wherein the relative movement is carried out by a conveyor.

21. The method as claimed in claim 20, wherein the conveyor is a belt conveyor or roller conveyor.

22. The method as claimed in claim 18, wherein the relative movement is carried out by a device for rotating a rotationally symmetric test object.

23. The method as claimed in claim 18, wherein the relative movement is carried out by a robot.

24. The method as claimed in claim 18, wherein an induction generator is operated in continuous wave motion.

25. The method as claimed in claim 18, wherein a heating of a point of the test object as the inductor approaches and/or a cooling after the inductor has passed, is recorded by the infrared camera.

26. The method as claimed in claim 25, wherein at least two images are recorded.

27. The method as claimed in claim 25, wherein camera data are resorted in adaptation to a path and a speed such that one point from a results series for a temperature over a period of time corresponds to one point of the test object.

28. The method as claimed in claim 27, wherein a single image is produced from the results series by evaluating the camera data taking the heating and cooling process into account.

29. The method as claimed in claim 18, further comprising:
using evaluation algorithms for zero image correction or pulse phase analysis.

30. The method as claimed in claim 18, further comprising:
masking out image areas without information.

31. The method as claimed in claim 18, further comprising:
suppressing geometric effects caused by a shape of the test object by subtracting an image sequence of an intact test object from an image of a defective test object or by subtracting these two result images after evaluation by pulse phase analysis.

32. The method as claimed in claim 18, further comprising:
saving a result image for defect documentation.

33. The method as claimed in claim 18, further comprising:
positioning the test object at a point;
recording a camera image;
evaluating the camera image; and
positioning the test object at another point such that a result image is created for the test object, wherein the result image is created by superimposing several camera images.

34. The method as claimed in claim 33, wherein the image is online evaluated as the image is being captured.

35. The method as claimed in claim 33, wherein the image is automatically evaluated.

36. A device for carrying out a method of scanning induction thermography for a non-destructive material examination of a test object, comprising:
an inductor including an infrared camera; and
a device for moving a test object relatively to the inductor along any single or multi-dimensional path, wherein a relative movement of the test object is independent from recording an image by the infrared camera.

37. The device as claimed in claim 36, wherein the device for moving the test object is selected from the group consisting of
sliding tables for an x, a y and/or a z direction,
a belt conveyor,
a roller conveyor,
a device for rotating a rotationally symmetric test object,
a robot, and
a combination thereof.
